(19) United States
(12) Patent Application Publication
(10) Pub. No.: US 2016/0021947 A1
(43) Pub. Date: Jan. 28, 2016

(54) Protective garment for an individual that maintains his "cool" look while inconspicuously protecting him

(71) Applicants: David DOR-EL, Los Angeles, CA (US); Itzhak Shalev, Bet Gamliel (IL)

(72) Inventors: David DOR-EL, Los Angeles, CA (US); Itzhak Shalev, Bet Gamliel (IL)

(21) Appl. No.: 14/444,115

(22) Filed: Jul. 28, 2014

(51) Int. Cl. A41D 13/015; C08J 3/02; A42B 1/08

(52) U.S. Cl. CPC A41D 13/015; A42B 1/08; C08J 3/02; C08J 2371/02; C08J 2379/02; C08J 2305/00

(57) ABSTRACT

The present invention is a protective garment for individuals which includes a hoodie with a hood and a pair of sleeves, a head protective element and elbow, shoulder, wrist, back and torso protective pads. The head protective element is coupled to the hood of the hoodie by a fastening system. Each of the elbow protective pads is coupled to the hoodie by a fastening system. Protective elements are spacer fabrics filled with a shear thickening (also known as dilatant) gel having flexibility and drape-ability so as not to degrade the natural “cool” look of a standard garment.

### BACKGROUND OF THE INVENTION

1. Field of the Invention

The present invention relates generally to a protective garment for an individual and more particularly to a protective garment that incorporates both style and protective elements.

2. Description of the Prior Art

Various forms of safety garments have been created for use in sports such as motorcycling, bicycling, skating and skate boarding. Many of these garments incorporate impact absorbing areas and abrasion resistant materials which improve wearer safety. The protection offered by these safety garments fall into two main categories: impact protection and abrasion protection. Padded areas, often within resilient cups that may be constructed of materials, such as Temper-foam, are often sewn into garments over impact-sensitive areas, such as over the knees, elbows, shoulders, ankles, and even over the spine. These impact absorbing sections are often referred to as “body armor”. Densely woven materials, generally provided in layers, are used within these safety garments for preventing abrasion over the remaining fleshy areas of the user. Traditionally one of the best materials for these safety garments has been thick leather (i.e. over 1.5 mm), as it provides abrasion resistance many times greater than traditional cloth materials. Newer materials such as ballistic nylon, Cordura, Gortex and Kevlar, along with armor sections, are being incorporated within otherwise traditionally constructed cloth garments in order to increase their abrasion resistance. These garments rely on the use of layers of dense durable abrasion resistant cloth materials to protect the wearer.

U.S. Pat. No. 6,151,714 teaches a protective pad for a joint surface of a wearer's limb during athletic activity, such as skating and skateboarding, has a cushioning element and a shielding element mounted thereto. The cushioning element has a body with a first surface to overlie the joint surface and an opposite second surface. The shielding element has a primary wall forming a domed central region surrounded by a peripheral flange engaged upon the second surface of the cushioning body. In the central region, the primary wall defines an outer, obstruction-engaging surface and an inner wall surface. The shielding element also has a plurality of inter-engaged support wall segments extending from the inner wall surface toward, but spaced from engagement with, the second surface of the cushioning body. The shielding and cushioning elements, in a central region of the cushioning body bounded by the peripheral flange and overlying the joint surface, together define, at rest, a cavity between the support wall segments and the second surface of the cushioning body. The shielding element is relatively more resistant to flexing than the cushioning element, and upon application of a force to the obstruction-engaging surface of the protective pad overlying the joint surface to be protected, the shielding element resists flexing as the cushioning element flexes to permit penetration of the joint surface into the cavity, thus to absorb force and protect the joint surface. The pads are for protection of joint surfaces, e.g. of the knee or elbow, during sports activities such as skating and skateboarding. Protective pads for joint surfaces, e.g., of the knee or elbow, to be worn during sports activities such as skating and skateboarding, are widely available. Many forms of protective padding are constructed as composite assemblies in which a shock absorbing layer is positioned within an outer shell and/or attached to a rigid plate. U.S. Pat. No. 5,496,610, U.S. Pat. No. 5,840,397 and U.S. Pat. No. 5,450,625 all describe composite pad assemblies having a shock absorbing layer in the form of a honeycomb. Other protective pads have been integrally formed by molding as described in U.S. Pat. No. D-298,669, U.S. Pat. No. 4,354,280 and U.S. Pat. No. 2,093,388.

Referring to FIG. 1 protective pads 10 are worn to protect the joint surfaces of the limbs (e.g., knees 4 and elbows 6) of a person 2 engaged in a sports activity such as skateboarding (as shown), skating, and the like. The protective pad 10 is positioned and secured upon the wearer's limb to overlie the surface of the joint 4, 6 to be protected, as will be described more fully below. The protective pad 10 includes a shielding element 12 and a cushioning element 14.

Referring to FIG. 2 in conjunction with FIG. 3 and FIG. 4 the cushioning element 14 has a generally planar cushioning body 16 with a first surface 18 for overlying the joint surface 20 to be protected and an opposite second surface 22. The cushioning body is formed, e.g., of fabric and flexible, resilient cushioning material such as expanded polymeric foam. The shielding element 12 has a primary wall 24 forming a domed central region 26 surrounded by a peripheral flange 28. The peripheral flange is engaged and secured, e.g. by stitching 38, upon the opposite second surface 22 of cushioning body 16. The primary wall 24, in the central region 26, defines an outer, generally smooth, obstruction-engaging surface 30 and an inner wall surface 32. The shielding element 12 further has a plurality of inter-engaged support wall segments 34 extending from the inner wall surface 32 toward, but with the lower edges 50 spaced from engagement with, the opposite second surface 22 of the cushioning body 16. The inter-engaged support wall segments 34 are arranged in a honeycomb pattern, as shown. The shielding element 12, consisting of the primary wall 24, the peripheral flange 28, and the inter-engaged support wall segments 34, is formed as an integral unit by molding of a suitable, semi-soft, resilient, transparent, synthetic resin material. The protective pad 10 is positioned to overlie the joint surface 20 to be protected by a pair of elastic straps 42 extending about the limb. The straps have free ends 44 releasably secured to the first surface 18 of the cushioning body 16 by cooperating elements 46, 48 of hook-and-loop type fasteners. The straps 42 allow the wearer to conveniently position and secure the protective pad 10 to overlie the joint surface 20 to be protected. The shielding element 12 and the cushioning element 14, in a central region 36 of the cushioning body 16 bounded by the peripheral flange 28 and overlying the joint surface 20 to be protected, together define, at rest, a cavity 40 of height H between the inter-engaged support wall segments 34 and the opposite second surface 22 of cushioning body 16. The shielding element 12 is relatively more resistant to flexing than the cushioning element 16, whereby, upon application of a force to the obstruction-engaging surface 30 of the protective pad 10 overlying the joint surface 20 of a wearer's limb to be protected, the shielding element 12 resists flexing as the cushioning element 14 flexes to permit penetration of the joint surface 20 into the cavity 40, reducing the height of cavity 40, e.g., to H′, thus to absorb force and protect the joint surface 20, e.g., against injury. Use of transparent synthetic resin to form the shielding element 12 allows the internal honeycomb structural walls 26 to be visible through the primary wall 24. This permits the wearer to make a visual inspection (e.g., damage assessment) of the internal dome structure.

U.S. Pat. No. 4,443,891 teaches a helmet for cyclists, skateboard runners and roller skaters which includes a shell of flexible and hard plate-shaped material and a damping means attached inside the shell. The shell in its plane has the form of an I with extended cross-pieces and with tips attached radially between the same, which tips extend from the connecting between the cross-pieces and the stem of the I. About at the center of the stem lateral tips are attached to both sides. The cross-pieces and tips are provided with attachment means in such a manner, that the free ends of one cross-piece after the bending of the stem can be connected to the free ends of the other cross-piece. The free ends of the tips can be attached to suitable holders on the lateral tips. The cross-pieces, tips and lateral tips can be designed as bands, and the attachment means be arranged so that the width and size of the shell can be adjusted. The damping means substantially is formed after the stem and lateral tips and is provided with lugs arranged so as to protect the temples. The shell is made of plastic, and the damping means of foamed plastic. It has become popular to cycle, but unfortunately the number of bicycle accidents has increased thereby. According to an investigation of the number of accidents, in which children up to 15 years' age were involved, bicycle accidents ranked as the second greatest group. In order to reduce the risks at such accidents, therefore, helmets have come into use, which are recommended also for adult cyclists, especially those participating in the traffic in greater cities. A helmet for cyclists, skateboard runners or roller skaters must meet certain requirements. The helmet must provide good ventilation, because its wearer advancing by his own efforts gets warm and begins to sweat more readily than either a mopedist or a motor-cyclist. The helmet should be adjustable and of low weight. It should not appreciably screen off sound nor reduce or disturb the visual field. The inside of the helmet shall be soft. The helmet also shall be esthetically attractive and have a low price. This implies that the manufacturing costs shall be low, and the costs for distribution and storage shall be as low as possible. The last-mentioned requirement can be met when the helmet is made of plate-shaped material portions formed in a special way, which portions the consumer himself can form and fix to suitable size. Helmets made of plate-shaped material are known previously. A construction, which is particularly suitable for children, is based on the idea that the helmet in unfolded state comprises a number of segments extending from a small central portion, which segments can be bent to the shape of the head so as to form a hood where the ends of the segments are held together by strings or bands. The width of the hood thereby can be changed as the child grows in size. With this construction, there is no continuous protective band about the head. In case of an accident, the segments easily are displaced so that the head more or less is unprotected.

Referring to FIG. 5 in conjunction with FIG. 6 a helmet consists of a piece of hard flexible material, for example plastic. The piece is punched out of a plate and has the form of an I with extended cross-pieces 2. Between the cross-pieces tips 3 are attached and extend radiated from the connection between the cross-pieces and the stem 4 of the I. At the center thereof lateral tips 5 are attached and directed one to each side. The tips and lateral tips have band-shape and are arranged symmetrically in relation to a line of symmetry 6 through the stem in its longitudinal direction. Owing to the band-shape, the connection has a certain extension in width, and said portions 7 extended in width will upon mounting of the helmet be located directly in front of the forehead and the back of the head, which thereby are effectively protected. The tips and cross-pieces are provided at their free ends with attachment means 8,9. The two cross-pieces of the I after bending of the stem can be interconnected at the free ends and the remaining tips are attached with their free ends in pairs to the holders 10 on the lateral tips. In this way, a helmet-like head cover is obtained, which has distance to the head and amply dimensioned slits between the tips, but with tight contact where the requirements for protection are greatest. The attachment means are designed so that the size of the helmet can be adjusted within certain limits. The adjustment means may be indents and/or holes. For the assembly, for example, screws with flat nuts can be used. For rendering the helmet as comfortable as desired and for effecting necessary shock-absorption, a damping means 11 punched out of plate-shaped material, for example foamed plastic, and formed after extended portions of the shell, lateral tips and stem is placed on the inside of the shell. One of the extended portions of the damping means is provided with lugs 12 of such location as to protect the temples. The damping means is attached in a suitable manner, for example on the stem, and by its elasticity is pressed against the inside of the shell. On the shell also hangers or lugs 13 for chin-bands are attached.

U.S. Pat. No. 6,589,891 teaches an abrasion resistant garment which is highly ventilated while providing abrasion protection for a wearer during a slide, as for instance that may occur during a fall from a motorcycle. A material is produced wherein abrasion-resistant, low sliding friction, beads are held within a matrix of high-tensile strength, abrasion-resistant, cords. The beaded matrix within the garment can be augmented with layers to form a lining and exterior layers to enhance visibility. The force of a sliding rider is retained over the beaded matrix, away from the road surface. Under abrasive sliding friction, the beads additionally rotate to an extent which tightens the cord matrix and thereby helps constrain the skin surface of the wearer from making contact with the roadway surface. Various forms of safety garments have been created for use in sports such as motorcycling, bicycling, skating and skateboarding. Many of these garments incorporate impact absorbing areas and abrasion resistant materials which improve wearer safety. The protection offered by these safety garments fall into two main categories: impact protection and abrasion protection. Padded areas, often within resilient cups that may be constructed of materials, such as Temperfoam, are often sewn into garments over impact-sensitive areas, such as over the knees, elbows, shoulders, ankles, and even over the spine. These impact absorbing sections are often referred to as “body armor”. Densely woven materials, generally provided in layers, are used within these safety garments for preventing abrasion over the remaining fleshy areas of the user. Traditionally one of the best materials for these safety garments has been thick leather (i.e. over 1.5 mm), as it provides abrasion resistance many times greater than traditional cloth materials. Newer materials such as ballistic nylon, Cordura, Gortex, Kevlar, along with armor sections, are being incorporated within otherwise traditionally constructed cloth garments in order to increase their abrasion resistance. These garments rely on the use of layers of dense durable abrasion resistant cloth materials to protect the wearer. Often minor abrasions are referred to as “road rash” wherein a slowly moving body contacts a roadway surface at a speed of under 15-20 mph. However in sports such as motorcycle riding, a fall at even moderate speed on a roadway surface can result in severe abrasions; whereby not only the skin is abraded away, but significant amounts of flesh, muscle, and bone can be similarly removed. Even moderate abrasion wounds are painful and slow healing. Severe abrasion wounds can result in a significant blood loss, an infection hazard, a likelihood of permanent disfigurement, and even death. Everyday clothing provides insignificant levels of abrasion resistance, such as to a motorcycle rider falling on a roadway. In Australia in 1982, the Royal Brisbane Hospital Burn Unit completed a 13½ year study of motorcycle burn injuries wherein 29% of the burn unit victims were road abrasion burns with 46% experiencing the burns to both upper and lower extremities. Of these the median hospital stay was 8 days, but ranged up to 186 days. It was concluded that proper safety clothing would have prevented all of these road abrasion burns. Similar studies have been conducted in England, Germany and other countries with similar results. Insurance industry and government committees have been looking closely into regulations directed at safety garments. At this time Germany is considering compulsory clothing standards which require motorcycle riders to wear certified safety garments, while the British Standards Institute of the British government is drafting standards for protective clothing for motorcycle riders. As can be seen, therefore, abrasion-resistant protective clothing should be worn when one is involved in any high speed activity where one is otherwise unprotected from abrasion as a result of a fall. However, the use of protective clothing is often ignored, even though equipment currently exists which can largely protect riders from impact and abrasion injuries. Part of the lack of acceptance of current safety garments may lie in the numerous drawbacks that are inherent in the designs which limit their proper habitual use. There are generally two principle forms of safety garments available for sports such as motorcycle riding; the first category is leathers, while the second is cloth type garments. Thick leather provides a good measure of protection and is favored by the majority of competitive riders. Its thickness and durability often requires that only a single layer is required to prevent abrasion. However the leather does not stretch nor does it allow air-flow to reach the wearer. Protection in the, many current cloth-type safety garments is provided by means similar to those used within ballistic protection gear, such as so called “bullet proof vests”; wherein a tightly closed material structure is created through which no objects can incur. Layers of densely woven Kevlar and carbon fibers have replaced steel chain-mail type construction in these protection suits. Within an abrasion resistant garment, numerous layers of material are utilized to provide redundancy as a layer wears through during a fall, and to provide thermal insulation. To further enhance protection against abrasion, more ballistic armor techniques have been considered, such as covering the exterior of the garment with closely spaced platelets. Within ballistic protection suits the platelets are intended to prevent ballistic incursion, but in this case have been considered to prevent roadway incursion. However, it will be appreciated that such approaches lead to the creation of a heavy garment that is substantially covered with anti-ballistic material. Opening up platelet spacing then leads not only to a garment that tears on impact, but one in which the friction forces rotate platelets, platelet halves, or platelet fragments, against the skin of the wearer inflicting additional injury. In general, abrasion resistant clothing follows the teachings of ballistic protection to provide abrasion protection. Unfortunately, both the leather and cloth designs, when promulgated as abrasion safety garments, restrict air-flow and consequently when worn in warm to hot weather are at best uncomfortable, and may in fact be unwearable, due to the high risk of hyperthermia. Thick garments such as these allow insignificant amounts of air to flow and thereby pose a dangerous hyperthermia risk as body temperatures can soar. It is not surprising that a large percentage of safety-conscious riders don't ride when it gets warm out, . . . . while others ride dangerous under-protected with street clothing. Clothing manufacturers have worked to provide various forms of venting for conventional safety garments, venting is unable to compensate for the bulk of layers of tightly woven material surrounding the wearer, and vents are of only minor aid when the wearer is stationary. To fully appreciate the situation, it should also be remembered that in the case of a motorcycle rider, the rider is seated above an engine operating at high temperature, the heat from which rises to envelop the rider. There is a need for abrasion resistant safety garments that can be constructed to minimally restrict ventilation of the wearer. The abrasion resistant conformal beaded-matrix in accordance with the present invention satisfies that need, as well as others, and overcomes deficiencies in previously known techniques.

Referring to FIG. 7 a torso protection garment 70 is constructed from the abrasion-resistant beaded matrix 72 shown with included body armor sections. The torso protection garment 70 is shown for clarity without an outer fabric shell while the cord connecting the beads is not visible in this overall view. Such a garment should include a number of additional safety features. Elbow armor 74a, 74b, and shoulder armor 76a, 76b provide hard abrasion-resistant exterior shells with dense foam shock absorbing liner material. The cords of the beaded matrix, sans beads, are sandwiched within the armor pads to assure that the armor is unable to separate from the cord matrix and thereby the remainder of the garment. Alternatively, the matrix of cords may be sewn into or around the armor sections for retaining the garment and armor in place. The ends of the garment terminating at the wrists 78a, 78b is reinforced and provided with a closure, such as a snap, so that the sleeve is retained over the forearm. During a slide the forearm may contact the ground such that the contact friction attempts to pull the sleeve portion of the garment away from the wrist. The sleeve is retained so that the wrist area does not become exposed to abrasion. A fastener, such as a snap, can be used to narrow the opening at the wrist after the hand has been inserted into the garment; the restricted opening thereby prevents the sleeve from substantial movement. Other alternative means of retaining the sleeve include attachment to a glove and the use of finger webbing, whereby one or more straps wrap around between the fingers of the hands. An underlining region 80 is provided to retain the torso garment from shifting around the midsection. If the bottom of the torso garment is not retained in some manner then the beaded matrix may shift under sliding force to expose large areas of the skin. The torso garment 70 is attached to a full length trouser garment that contains an abrasion resistant beaded matrix and armor sections. The neck 82 of the garment is reinforced and may be equipped with snaps to prevent gaps around the neck area. A garment may be alternatively fabricated in a coverall style so that the interface between an upper and lower portion does not exist. In use, this beaded matrix offers a unique mode of protecting the wearer.

Referring to FIG. 8 a series of beads 90 are under abrasive contact with an asphalt surface. For clarity a row of beads is shown in isolation without coverings, other beads or body portions. The skin of the wearer is held above the pavement riding on a beaded surface. Between the beads 92a through 92c are gaps where no protective material may exist. The wearer's skin does not contact the asphalt surface 96 due to the matrix of cords 94a through 94d which retain the skin above the pavement surface. Furthermore, under the sliding friction the beads tend to rotate to cause the cord matrix to tighten within that area of the garment to more securely retain the body area off of the pavement. During a very short interval as a result of an initial high-G impact it may be possible for small portions of the skin to make incidental contact with the ground through the openings in the matrix, but as the force translates to a sliding force then only the weight of the rider should then be held above the beads during the slide. Should such incidental contact occur it would not result in significant injury. A limited stretch fabric be used within an optional lining to provide comfort and to prevent even incidental contact as it provides a trampoline effect between the beads in the matrix. The underside of each bead 92a through 92c can be easily seen in this view to proffer a smooth surface at the interface with the pavement 96. Smooth transitions with the pavement reduce the chances of the material “catching” the ground. When a material under abrasive sliding contact catches the ground, the forces on the garment drastically increase at that location, since the entire momentum of the rider may be temporarily caught at that one point, whereby the chances of tearing the garment increase and rotational torque forces applied to the sliding body can increase dramatically leading to increase the risk of fractures.

Referring to FIG. 9 a completed trouser 310 incorporates the beaded matrix. The trouser 310 has a waistband 312 from which leg portions 314 extend. The waistband 312 includes a horizontal loop of material 316 secured in a closed position by a fastener 318. The portions of the leg 314 are covered by a combination of beaded matrix 320 upon which are attached impact resistant body armor at strategic locations, such as at sections 322 (over the hip bone) and 324 over the knee joint. The lower portion of the garment terminating at the ankle is configured with a band 326 which is securely retained in a closed position by a fastener 328, such that the material matrix may not egress from the ankle area upon the application of force during sliding. The beaded matrix may be utilized over more limited regions within a garment as to provide for air-flow without the loss of abrasion resistance.

U.S. Pat. No. 6,910,698 teaches safety clothing which is suitable for use when skateboarding or in other similar activities. The clothing has pockets in the inside thereof to removeably receive cushioning or energy absorbing material, typically in sheet form, such as closed cell foam, so as to be invisible to the casual observer, but to offer substantial protection to body parts such as hips, knees and the like. Skateboards and the riders of them have, over the past few years, propelled the sport into an art form. Many maneuvers are performed that appear to defy gravity.

Referring to FIG. 10 in conjunction with FIG. 11 and FIG. 12 an item of clothing 44 may incorporate a series of pockets located in strategic areas where the body needs protection from a fall. The pockets are sewn into the clothing. An impact absorbing material 46 is assembled into sections. The item of clothing 44 may incorporate a series of pockets located in strategic areas where the body needs protection from a fall. The pockets are sewn into the clothing, typically on the inside of the clothing so as to not be visible. The impact absorbing material 46 is assembled into sections, to allow the person wearing the clothing to perform in the activity, the protective pads being unobtrusive, yet protecting the person in the event of a fall.

U.S. Pat. No. 5,717,997 teaches a form-fitting garment which has side pockets that allow hip pads for the protection of the greater trochanter to be securely positioned and centered above the greater trochanter region. The hip pads have a slit extending through the planar surface that is centered over the greater trochanter region and disperses any impact forces against the pad away from the greater trochanter region. At a time when health care costs are escalating, medical research continues to focus on preventative medicine. The study of geriatrics has revealed that elderly individuals have an increased risk of hip fractures and deaths related to hip fracture disease. Included within the elderly group are several groups at greater risk. Among some of these greater at-risk groups are: persons, particularly females, over age 50, persons with chronic medical conditions, persons with impaired acuity, persons with osteoporosis, and persons with bodies having low muscle/fat content. The most frequent cause of hip fractures results from a fall, including light falls. In the past, various devices have been constructed to prevent hip injuries. These devices include hip pads used by athletes while playing soccer, hockey and baseball and also by skiers. Devices have also been constructed to prevent such injury among the elderly. These devices often contain a recess in the pad that must be aligned in position directly above the greater trochanter region. These pads have been taped or strapped in place causing slight discomfort to the elderly person. When strapped in place, the pads have a tendency to slip becoming misaligned with the greater trochanter. The slipped pads decrease the effectiveness of protecting the greater trochanter from fractures. Further, these devices are often difficult to place in position directly surrounding the greater trochanter area. Medical assistance may be required to properly position and secure the pad to the hip. The hip pads are manufactured in a variety of sizes thereby increasing the costs of manufacture.

U.S. Pat. No. 8,756,713 teaches a garment which has a hood and in which three groups of connectors are installed on and around the opening edge of the hood surrounding the face of the wearer. Each group of connectors is positioned at a vertex of a triangle shape. When the hood has been put on the head of the wearer, the exposure area of the wearer's face is to be adjusted to be smaller or larger, by tightening or untightening one pair, or more than one pair of the connectors. When tightened, the hood forms a better thermo-insulation and provides better protection for the user against severe weather including cold, wind and snow. Today, hoods are generally soft head coverings which form part of a larger garment, the hoodie. They can be pulled up over the head when needed, or left to hang down the back when not. They may also be detachable to turn a winter overcoat into a summer one.

Referring to FIG. 13 the garment has a body of the garment, a hood and three groups of connectors on and around the opening edge of the hood wherein the opening edge is the edge that surrounds the face of the user of the hood. Each group of the three groups of connectors is located at a vertex of a triangle shape in relative spatial position. The first group of connectors is located in the vertex that is just under the chin of the user, the second group of connectors is located at the vertex that is on the left side of the face of the user, and the third group of connectors is located at the vertex that on the right side of the face of the user. Each group of connectors includes one pair or more than one pair of connectors, with each pair of connectors having one male connector and one female connector. The male connector can only be connected to the female connector of its own pair. In the first group of connectors the male connectors and the female connectors are on a different side of the edge of the hoodie. If the male connectors are on the left side, the female connectors must be on the right side. The male and the female connectors m t cross over from left to right in order to be connected together. In the second group (or third group) of connectors, the male connectors and the female connectors are on the same side of the edge of the hoodie. If the male connectors are on the left side (or right side) then the female connectors must be on the same side with the male connector. The male and the female connectors do not cross over from left to right in order to be connected together. The connection force axis 18 clearly indicates the position of the connectors. The zipper slider is not a secure means to keep the upper end of the zipper in a closed condition. The quality of the first group of connectors is therefore critical. The hood can be made with or without the traditional “drawstring.” The hood can be put on the head of the user to cover the head, the neck and part of the face when needed by the user. The hood, when it has been put on the head of the user, can be tightened/untightened by closing/opening one pair or more than one pair of connector(s) around the edge of the hood, so that the opening area around the face of the user is reduced/enlarged by direct closing/opening or by folding/un-folding the edge of the hood. The connectors can be made of different forms and different material, and they can be of, include but not limited to snap fasteners, buttons and buckles. The connectors on the hood should be made to have sufficient connection force to connect two parts of the cloth together tightly when the connectors are closed. The connectors should be able to be opened only by enough hand force. The connectors on the hood should be made of material that is durable and strong enough to withstand repeated on and off operations without decrease in functionality and deformation in shape. When the hood is tightened, the user has unobstructed vision. When the hood is tightened, it does not block the steam from the mouth and nose of the user. The hood can be attached to the body of the clothing by zippers, or by buttons, or by snap fasteners, or by other means of connection, or permanently sewn to the body of the article of clothing. The hood may be made with a sweater, or with a suit jacket, or with other clothing.

US Patent Publication No. 2011/0289 649 teaches a super hoodie which is similar to a conventional hooded sweatshirt (hoodie) with added inner material that attaches completely near the bottom, up along one side of the zipper to the other, and to the lower portion of the arm holes, creating a large inner pocket in the hoodies. Additional pockets, slits, and accessories can be added to either side of the inner pocket material. Conventional hooded sweatshirts (hoodies) generally have one or two pockets sewn to the outside of the garment. The pockets are not very large. This invention gives the garment a large carrying capacity without changing the look of the garment on the outside. The super hoodie adds a large inner pocket that runs from one side of the zipper to the other on the inside of the garment. By adding a large inner pocket, the garment can now carry larger items that a conventional hoodie cannot without sacrificing the common look of the hoodie. A large inner pocket is created by attaching additional material to the inside of the garment. The material is attached completely near the bottom of the garment. It is also attached close to both sides of the zipper without hampering the zippers ability to perform the closing action. To give the pocket added stability, the inner material is attached to the lower portion of the inner arm holes. Additional pockets, slits and accessories can be added to either side of the inner pocket.

US Patent Publication No. 2013/0152269 teaches a hoodie which has a holder pouch on the outside of a hand warmer panel with an open top able to be selectively closed with mating hook and loop strips. Such garments have a sewn on panel in the lower part of the front of the garment, forming a single space, partially open at either side so as to allow a wearer to insert his or her hands therein to keep them warm. Wearers often try to store items such as a cell phone behind the hand warmer panel, but the presence of the side hand openings precludes securely retaining anything put in the pouch. Gamers have a particular need to hold portable game consoles to free up their hands in order to use a cell phone while carrying the game consoles.

Referring to FIG. 14 a hoodie which is adapted to be worn on the upper torso and which includes traditional parts of a hood, long sleeves and a body shirt having a fabric hand warmer panel sewn to the front of the body shirt. The hand warmer panel is sewn to the body shirt with the top and bottom stitching. The panel is unattached along major portions of either side to allow a wearer to place his or her hands into a space defined behind the panel. Reinforcing stitched hem is typically included along the open portions of either side of the panel. An additional generally rectangular fabric panel is sewn to the outside of the front of the hand warmer panel along the bottom and the two sides, but left unsewn across the top, to form a pouch for receiving objects such as a cell phone or gaming console. The top edge is adopted to be selectively opened or closed by a closure extending across the top. The closure includes mateable hook and loop strips which may not extend completely across the top. This allows passage of a cord as for ear plugs or a game controller as shown. A provision for conveniently holding various objects is provided for a hoodie garment or other garments having a hand warmer panel. A sweatshirt not having a hand warmer panel could also be provided with a pouch as shown. Protecting young people who engage in potentially hazardous activities such as skateboarding, in-line skating, break dancing and freestyle cycling, is a difficult endeavor. Bulky and unattractive protective gear is often shunned as being “uncool” and a bother to carry around, don and doff.

The applicants hereby incorporate the above referenced patents and patent publications into their specification.

### SUMMARY OF THE INVENTION

The present invention is generally directed to protective garments for individuals who are at risk of fall injury such as cyclists, skiers, skateboarders, security personnel, seniors and impaired mobility control persons. The protective garment includes a hoodie with a hood and a pair of long sleeves, long pants and unobtrusive protective elements composed of 3 to 20 millimeters thick gel filled spacer fabric,

In a first aspect of the present invention the head protective element is coupled to the hood of the hoodie by a fastening system.

In a second aspect of the present invention each protective element is coupled to one of the garment parts of the hoodie or pants by a fastening system.

In a third aspect of the present invention the protective garment incorporates style, flexibility and protective elements.

In a fourth aspect of the present invention the protective garment maintains a look that most individuals think is “cool.”

In a fifth aspect of the present invention the protective garment provides protection of other more conspicuous protective garments inconspicuously.

Other aspects and many of the attendant advantages will be more readily appreciated as the same becomes better understood by reference to the following detailed description and considered in connection with the accompanying drawing in which like reference symbols designate like parts throughout the figures.

The features of the present invention which are believed to be novel are set forth with particularity in the appended claims.

### DESCRIPTION OF THE DRAWINGS

FIG. 1 is a diagrammatic view of a person engaged in an athletic activity, here, a skateboarder, wearing knee and elbow protective pads according to U.S. Pat. No. 6,151,714.

FIG. 2 is a top view of a protective pad according to U.S. Pat. No. 6,151,714 with the fastener straps in open condition; and

FIG. 3 is a side view of the protective pad of FIG. 2 taken at line 3-3 of FIG. 2 with the fastener straps in closed condition.

FIG. 4 is a section view of the protective pad of FIG. 2 taken at line 4-4 of FIG. 2 with the joint to be protected partially shown, the protective pad in a non-impact condition.

FIG. 5 is a plan view of the tipped piece of plate-shaped material constituting the shell of the helmet according to U.S. Pat. No. 4,443,891.

FIG. 6 is a slightly perspective view of the tipped piece of shock-absorbing plate-shaped material which is to be attached on the inside of the shell of the helmet of FIG. 5.

FIG. 7 is a front view of a torso protection garment constructed from an abrasion-resistant beaded matrix with included body armor sections according to U.S. Pat. No. 6,589,891.

FIG. 8 is an edge view diagram of the abrasion-resistant beads of the abrasion-resistant beaded matrix of FIG. 7 in sliding contact with a pavement surface.

FIG. 9 is a front view of a trouser protection garment constructed from the abrasion-resistant beaded matrix of FIG. 7 and having included body armor sections.

FIG. 10 is a partial perspective view of an item of clothing which incorporates a series of pockets located in strategic areas where the body needs protection from a fall according to U.S. Pat. No. 6,910,698.

FIG. 11 is a plan view of the item of clothing of FIG. 10 which shows pockets that are sewn into the item of clothing.

FIG. 12 is a perspective view of an impact absorbing material which is assembled into sections.

FIG. 13 is an elevation view of the hoodie with three groups of connectors on the opening edge of the hood according to U.S. Pat. No. 8,756,713.

FIG. 14 is a perspective view of a hoodie according to US Patent Publication No. 2013/0152269.

FIG. 15 is a diagrammatic view of a person engaged in an athletic activity, here, a skateboarder, wearing knee and elbow protective pads according to a first embodiment of the present invention.

FIG. 16 is a perspective view from the front of a hoodie according to a second embodiment of the present invention.

FIG. 17 is a photograph of an unobtrusive protective elements composed of 3 to 20 millimeters thick gel filled spacer fabric according to a third embodiment of the present invention.

FIG. 18 is a schematic drawing of the unobtrusive protective elements of FIG. 17,

FIG. 19 is a front facing schematic drawing showing where the unobtrusive protective elements of FIG. 17 may be placed.

FIG. 20 is a rear facing schematic drawing showing where the unobtrusive protective elements of FIG. 17 may be placed.

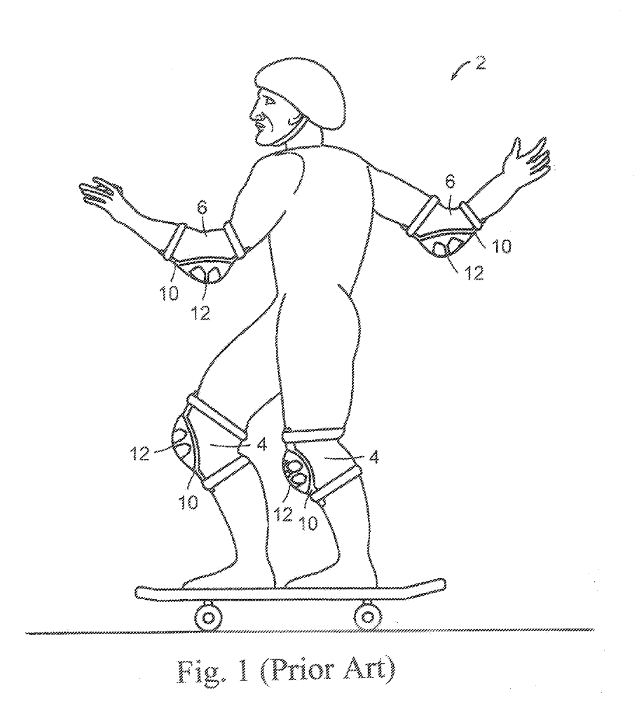

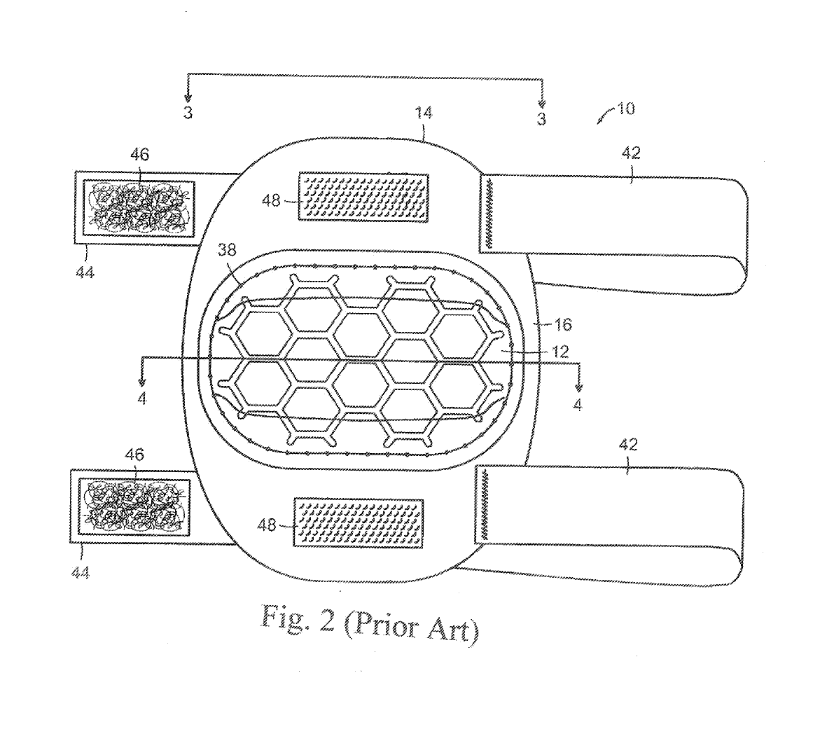

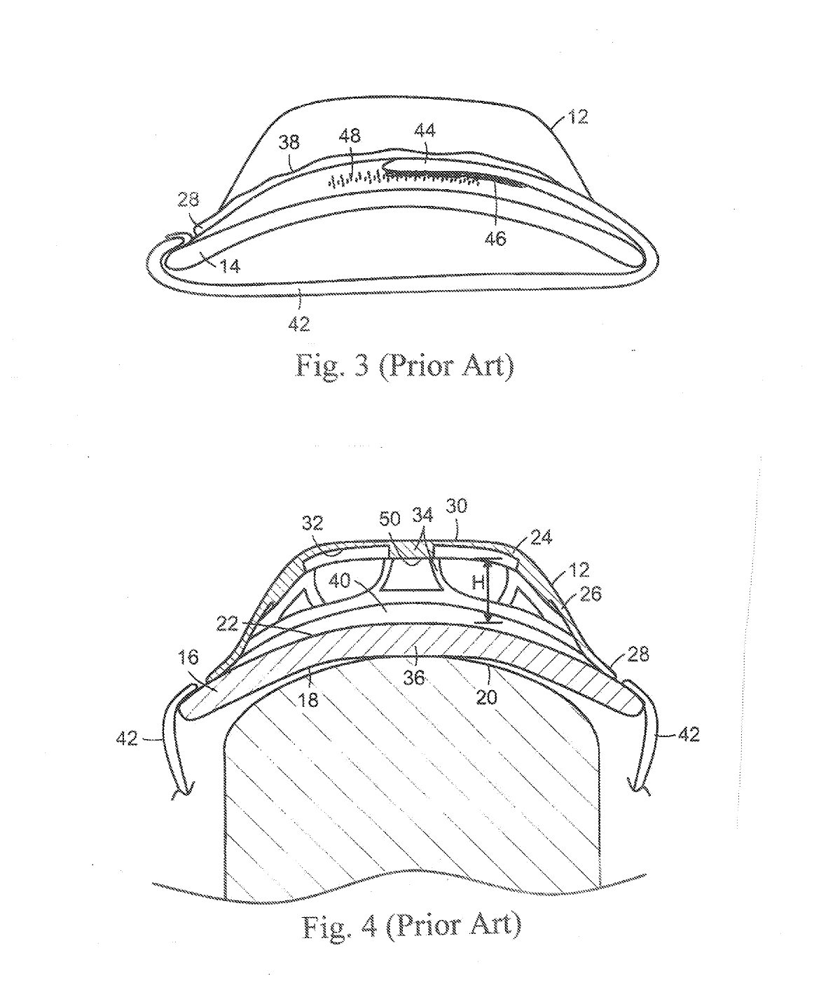

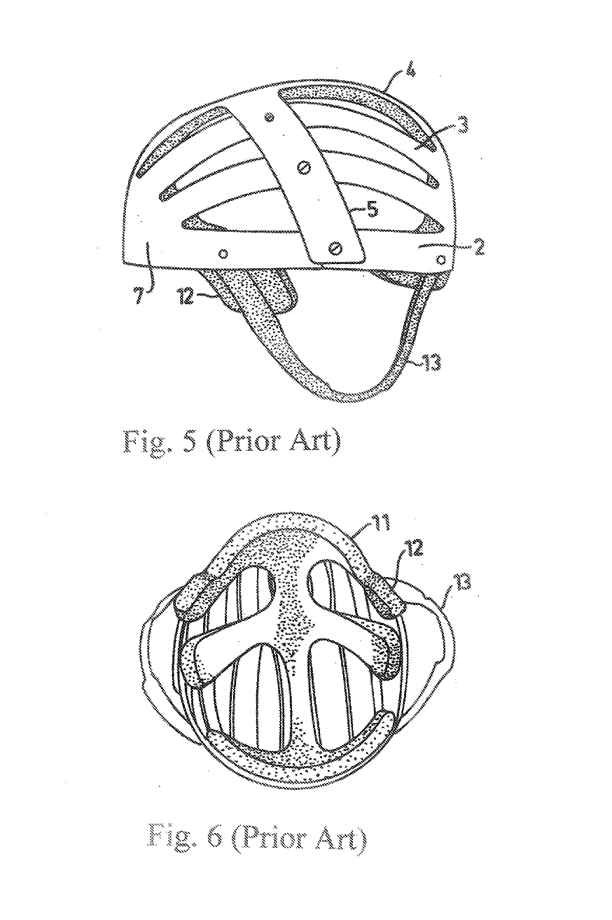

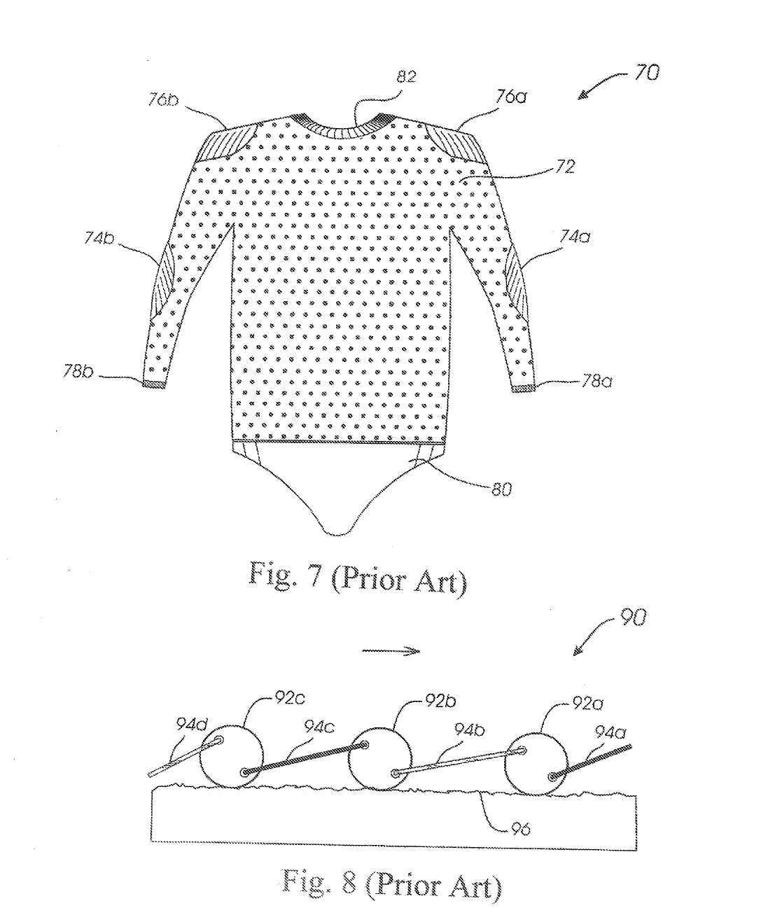

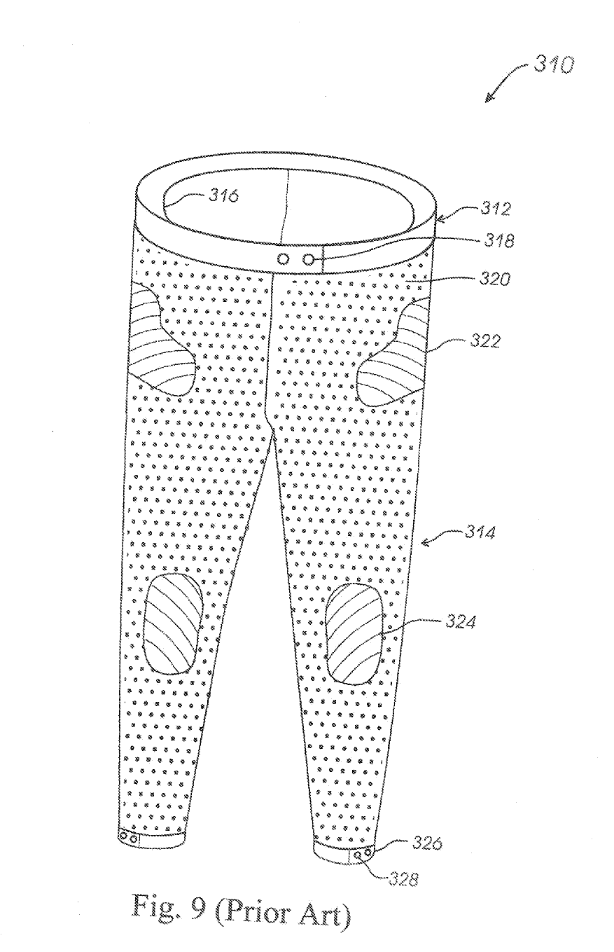

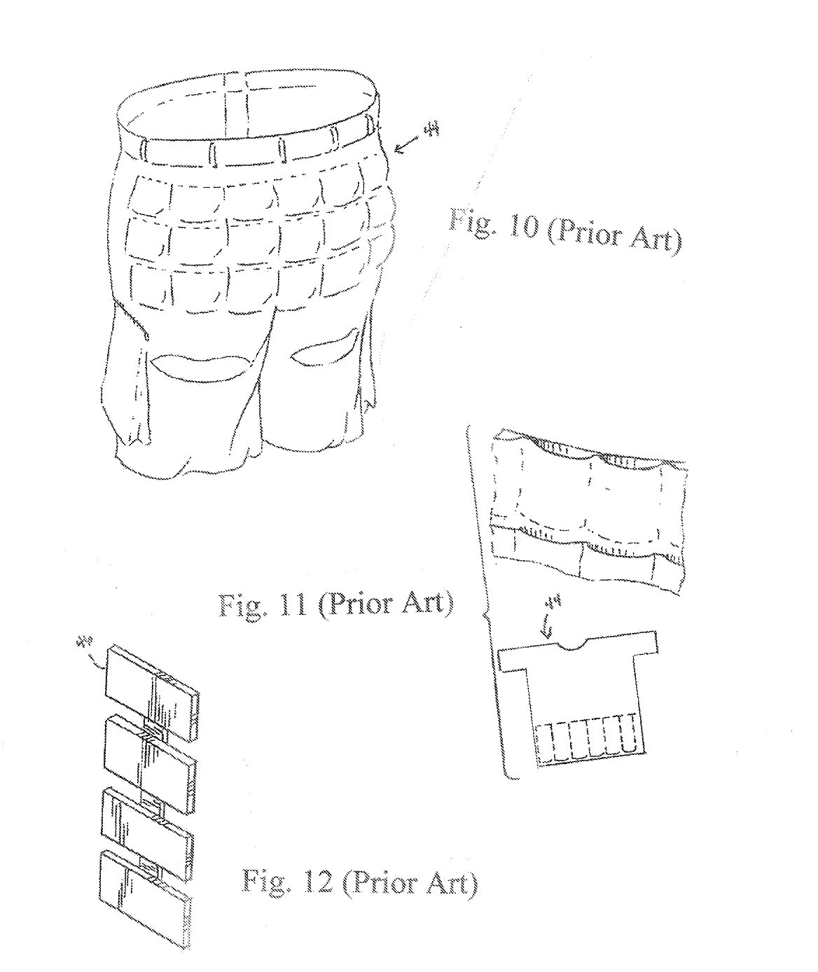

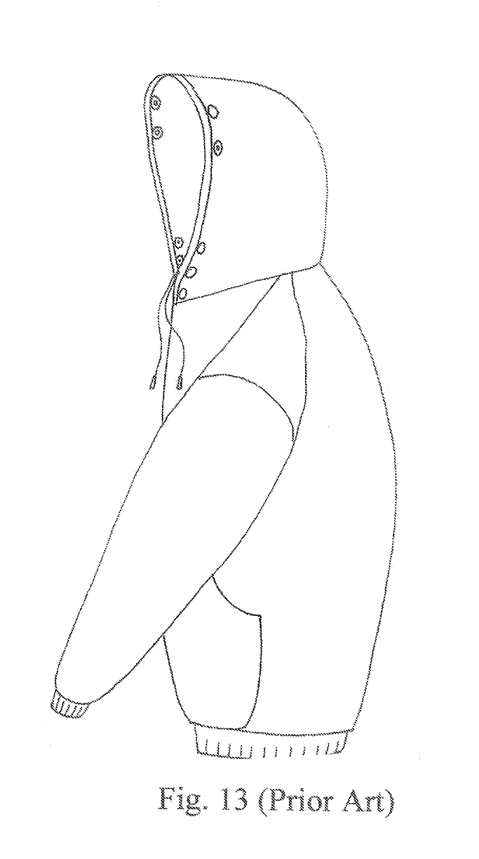

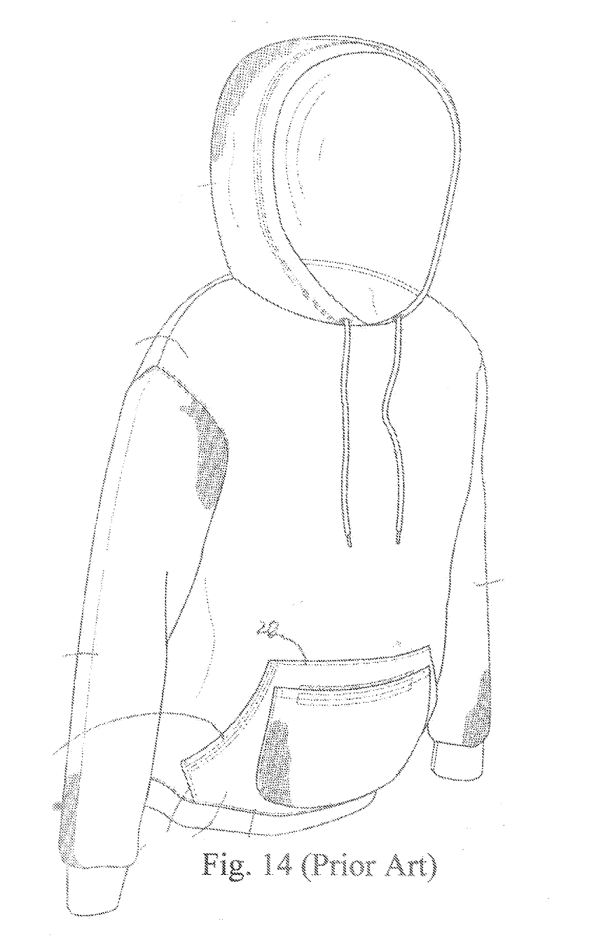

### DESCRIPTION OF PREFERRED EMBODIMENTS

The solution of Incorporating protective elements directly into popular street-wear styles require that the protective components be flexible, breathable, lightweight and, generally, indistinguishable to the untrained eye from regular garments. This goal can be achieved with a combination of smart garment design and revolutionary “spacer fabrics”, now available on the market, especially modified by Cool Space Ltd. for this application. Spacer fabrics have three layers with monofilament yarns standing between upper and backing fabrics. Spacer fabrics are not three different fabrics laminated or glued together, instead they are all knitted together on a Raschel knitting machine. The fabric works as one unit, sharing load, elongation and stress. Spacer fabrics are very lightweight, compressible and they breathe. The air-spaced interior core is crush resistant, resilient (bounces back), well ventilated and moves moisture away from the body. These fabrics have the stretch-ability, compressibility and resiliency of conventional foam material such as neoprene, latex, EVA and PU, while providing enhanced flexibility, drape, launder-ability and air/moisture permeability. Thickness can vary from 3 to 20 mm and a wide variety of fibers can be used in the three layers.

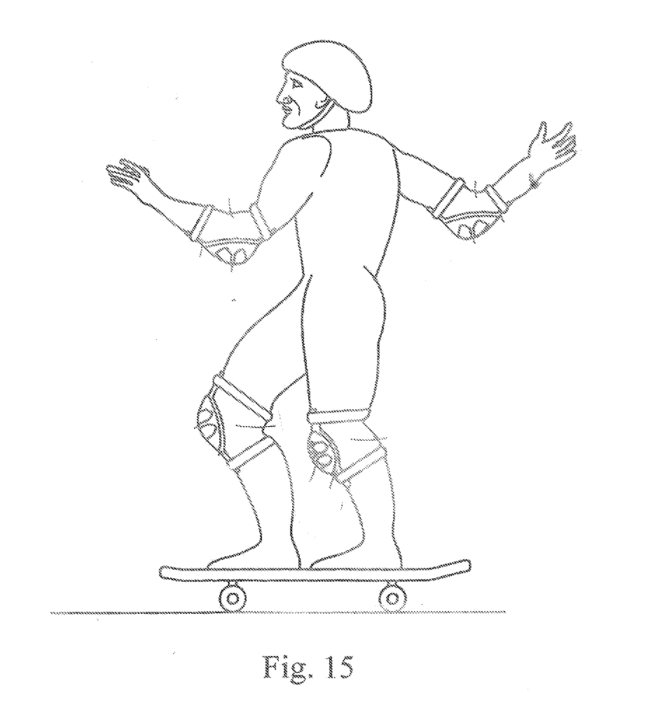

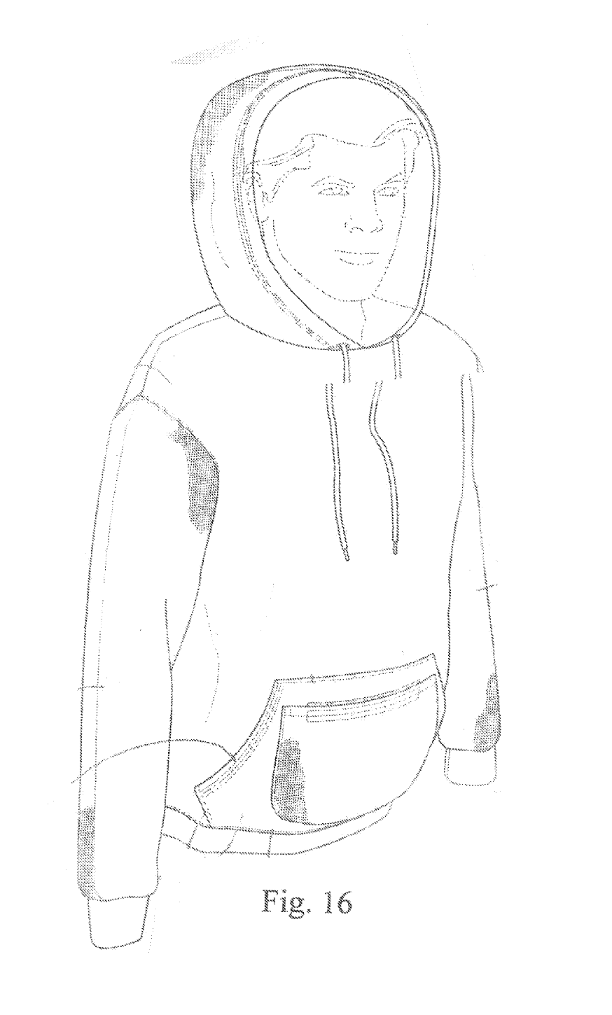

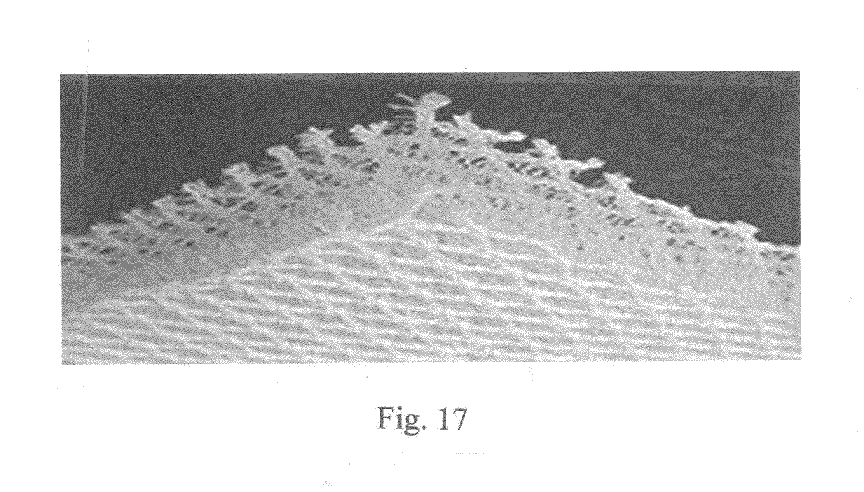

Referring to FIG. 15 in conjunction with FIG. 16 and FIG. 17 a protective garment 110 for individuals includes a hoodie 111 with a hood 112 and a pair of long sleeves 113 and unobtrusive protective elements composed of 3 to 20 millimeters thick gel filled spacer fabric. A helmet 120 is coupled to the hood 111 of the hoodie 110 by a fastening system. A pair of elbow protective pads 130 each of which is coupled to one of the long sleeves 113 of the hoodie 110 garment by a fastening system. The protective garment not only maintains a look that most individuals think is “cool,” but also provides protection of other more conspicuous protective garments inconspicuously.

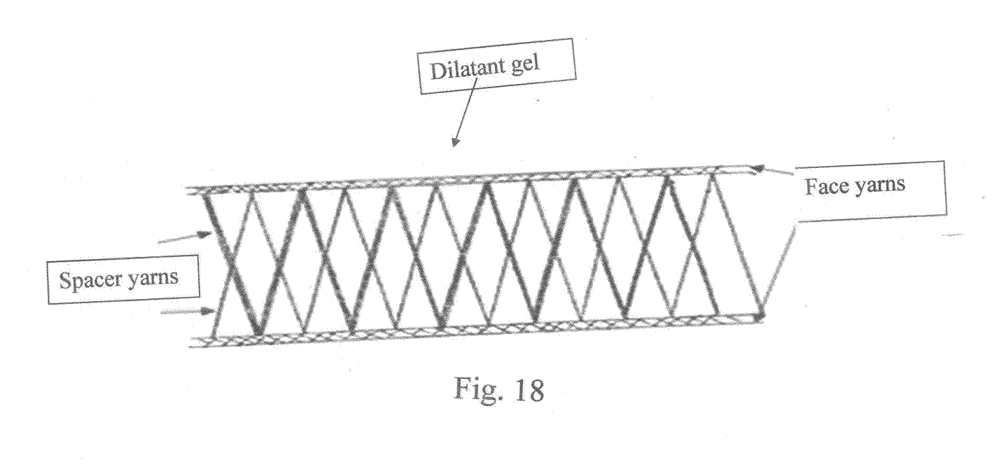

Referring to FIG. 17 in conjunction with FIG. 18 the protective elements are spacer fabrics 140 filled with a shear thickening (also known as dilatant) gel 141 and sealed around the perimeter. The spacer fabrics contain gels yielding enhanced impact protection (reduction of >80% in transmitted force at 10 Joules when tested according to EN1621-1) stemming from the combination of the resiliency inherent in the spacer fabric construction principle and the reaction of the contained gel to impact and shear. The protective elements have flexibility and drape-ability so as not to degrade the natural “cool” look of a standard garment.

The dilatant gel is composed of one or more of the following combinations: silica nano-particles dispersed in a solution of poly (ethylene glycol), silicone oil and boric acid, mixed suspensions of silica colloid and hyper-branched poly-ethylene-imine, cetyl-tri-methyl ammonium bromide and sodium salicylate, polysaccharides or other shear thickening colloids known in the art

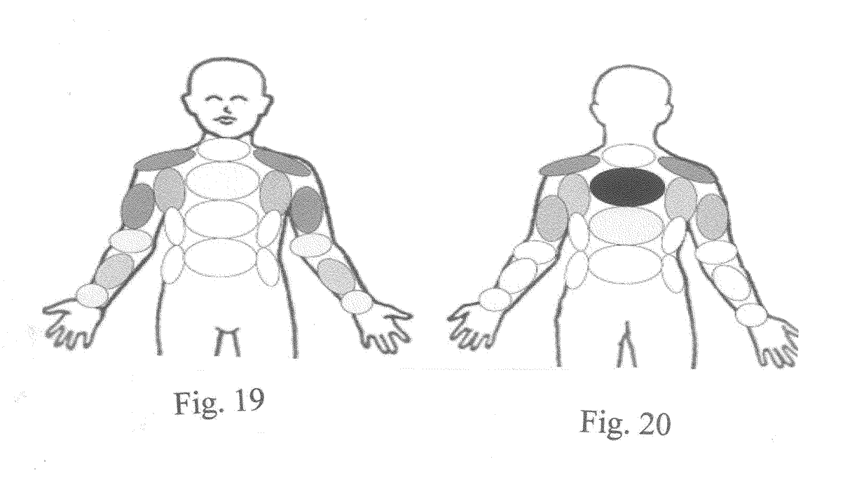

Referring to FIG. 19 in combination with FIG. 20 possible placements of pads 150 are shown for the hoodie 110.

In another embodiment a protective garment for individuals includes a pair of pants with a pair of pant legs and a pair of knee protective pads each of which is coupled to one of the pant legs of the pair of pant legs of the pair of pants by a fastening system. The protective garment not only maintains a look that most individuals think is “cool,” but also provides protection of other more conspicuous protective garments inconspicuously. The protective elements are spacer fabrics filled with a shear thickening (also known as dilatant) gel and sealed around the perimeter and wherein said spacer fabrics contain gels yielding enhanced impact protection (reduction of >80% in transmitted force at 10 Joules when tested according to EN1621-1) stemming from the combination of the resiliency inherent in the spacer fabric construction principle and the reaction of the contained gel to impact and shear. The protective elements have flexibility and drape-ability so as not to degrade the natural “cool” look of a standard garment. The dilatant gel is composed of one or more of the following combinations: silica nano-particles dispersed in a solution of poly(ethylene glycol), silicone oil and boric acid, mixed suspensions of silica colloid and hyper-branched poly-ethylene-imine, cetyl-tri-methyl ammonium bromide and sodium salicylate, polysaccharides or other shear thickening colloids known in the art. The outer garment is designed to enhance a “cool” appearance of the wearer. Modular openings are incorporated around the protective elements to exhibit body art such as tattoos or piercings. The protective elements, described more fully below, are incorporated in sections of the garment which require enhanced protection such as the hoodie, elbows, lower back, hips and shoulders. Due to the design of the protective elements they maintain flexibility and drape-ability of the garment thus not detracting from the “cool” look. The protective elements are covertly assimilated in the garment.

The protective elements are comprised of spacer fabrics filled with a shear thickening (also known as dilatant) gel and sealed around the perimeter. The elements are precut to the appropriate shapes for incorporation at the above mentioned body parts, using conventional pattern cutting and grading techniques known in the art. The use of spacer fabrics to contain the gels has two purposes which surprisingly yield the desired result claimed in this disclosure.

Enhanced impact protection (reduction of >80% in transmitted force at 10 Joules when tested according to EN1621-1) stemming from the combination of the resiliency inherent in the spacer fabric construction principle and the reaction of the contained gel to impact and shear, and, ease of fabrication using traditional cut and sew techniques known to the industry. The resulting protective element also has flexibility and drape-ability so as not to degrade the natural “cool” look of a standard garment. The dilatant gel is composed of one or more of the following combinations: silica nano-particles dispersed in a solution of poly (ethylene glycol), silicone oil and boric acid, mixed suspensions of silica colloid and hyper-branched poly-ethyleneimine, cetyl-trimethyl-ammonium bromide and sodium salicylate or other shear thickening colloids known in the art.

The main types of protection required for street sports are protection from falls and from scrapes. The former requires compressible energy absorption and the latter requires abrasion tear resistance. Properly modified spacer fabrics provide both while having good aesthetics and easy incorporation in fashionable garments. There are decorative aspects in that both East coast and West coast style street-wear is available. The fashionable protective street-wear has integrated transparent panes which can show off tattoos and other body decorations. The same rationale is used for protecting the elderly from bone breaking falls that can severely impact their subsequent quality of life. “Normal” looking garments which incorporate protective spacer fabric elements can prevent hip joint fracture in the event of a fall. Some statistics on elderly falls (Source: Colorado State University). The risk of falling increases with age and is greater for women than men. Annually, falls are reported by one-third of all people 65 and older. Two-thirds of those who fall will fall again within six months. Falls are the leading cause of death from injury among people 65 or over. Approximately 9,500 deaths in older Americans are associated with falls each year. The elderly account for seventy-five percent of deaths from falls. More than half of all fatal falls involve people 75 or over, only 4 percent of the total population. Among people 65 to 69, one out of every 200 falls results in a hip fracture, and among those 85 or over, one fall in 10 results in a hip fracture. One-fourth of those who fracture a hip die within six months of the injury. The most profound effect of falling is the loss of independent functioning. Twenty-five percent of those who fracture a hip require life-long nursing care. About 50 percent of the elderly who sustain a fall-related injury will be discharged to a nursing home rather than return home. Most falls do not result in serious injury. However, there is often a psychological impact. Approximately 25 percent of community-dwelling people 75 or over unnecessarily restrict their activities because of fear of falling. The majority of the lifetime cost of injury for people 65 or over can be attributed to falls.

Uniformed professionals spend a great deal of time on bicycles, motorcycles, horseback and Segways and are therefore at increased risk of fall injury. A balance needs to be struck between an elegant, distinguished looking uniform and personal protection. Using CoolSpace Ltd. technology, the protective aspect can be built right in.

Protective garments constructed using CoolSpace Ltd technology have been submitted to the Israel Standards Institute (ISI) for performance evaluation according to accepted standards

From the foregoing it can be seen that protective garments constructed by CoolSpace technology have been described.

Accordingly it is intended that the foregoing disclosure and showing made in the drawing shall be considered only as an illustration of the principle of the present invention.

What is claimed is:

1. A protective garment for individuals comprises:
a. a hoodie with a hood and a pair of long sleeves and unobtrusive protective elements composed of 3 to 20 millimeters thick gel filled spacer fabric,
a hoodie with a hood and a pair of sleeves;
b. a protective element being coupled to said hood of said hoodie by a fastening system; and
c. Elbow, shoulder, wrist, back and torso protective pads elements each of which being coupled to one of parts of said sleeves of said hoodie garment by a fastening system whereby said protective garment not only maintains a look that most individuals think is “cool,” but also provides protection of other more conspicuous protective garments inconspicuously.

2. A protective garment according to claim 1 wherein said protective elements are spacer fabrics filled with a shear thickening (also known as dilatant) gel and sealed around the perimeter wherein said spacer fabrics contain gels yielding enhanced impact protection (reduction of >80% in transmitted force at 10 Joules when tested according to EN1621-1) stemming from the combination of the resiliency inherent in the spacer fabric construction principle and the reaction of the contained gel to impact and shear.

3. The protective elements of claim 2 having flexibility and drape-ability so as not to degrade the natural “cool” look of a standard garment.

4. The dilatant gel of claim 3 composed of one or more of the following combinations: silica nano-particles dispersed in a solution of poly (ethylene glycol), silicone oil and boric acid, mixed suspensions of silica colloid and hyper-branched poly-ethylene-imine, cetyl-tri-methyl ammonium bromide and sodium salicylate, poly-saccharides or other shear thickening colloids known in the art

5. A protective garment for individuals comprises:
a. a pair of pants with a pair of pant legs; and
b. a pair of knee, hip, buttocks and ankle protective pads elements each of which being coupled to one of said pant legs of said pair of pant legs of said pair of pants by a fastening system whereby said protective garment not only maintains a look that most individuals think is “cool,” but also provides protection of other more conspicuous protective garments inconspicuously.

6. A protective garment according to claim 5 wherein said protective elements are spacer fabrics filled with a shear thickening (also known as dilatant) gel and sealed around the perimeter and wherein said spacer fabrics contain gels yielding enhanced impact protection (reduction of >80% in transmitted force at 10 Joules when tested according to EN1621-1) stemming from the combination of the resiliency inherent in the spacer fabric construction principle and the reaction of the contained gel to impact and shear.

7. The protective elements of claim 6 having flexibility and drape-ability so as not to degrade the natural “cool” look of a standard garment.

8. The dilatant gel of claim 7 composed of one or more of the following combinations: silica nano-particles dispersed in a solution of poly(ethylene glycol), silicone oil and boric acid, mixed suspensions of silica colloid and hyper-branched poly-ethylene-imine, cetyl-tri-methyl ammonium bromide and sodium salicylate, polysaccharides or other shear thickening colloids known in the art.
